(19) United States
(12) Patent Application Publication
(10) Pub. No.: US 2025/0353274 A1
(43) Pub. Date: Nov. 20, 2025

(54) A METHOD FOR SEALING A SUBSTRATE

(71) Applicant: SIKA TECHNOLOGY AG, Baar (CH)

(72) Inventors: Gianpaolo AGANETTI, Castel d'Azzano (IT); Juliana Malvestio GRIPPA, Zurich (CH)

(73) Assignee: SIKA TECHNOLOGY AG, Baar (CH)

(21) Appl. No.: 18/869,484

(22) PCT Filed: Jun. 7, 2023
(86) PCT No.: PCT/EP2023/065246

§ 371 Date: Nov. 26, 2024

(30) Foreign Application Priority Data
Jun. 7, 2022 (EP) 22177604.0

(51) Int. Cl. B32B 3/18; B32B 5/02; B32B 7/12; B32B 11/08; B32B 11/10; B32B 15/14; B32B 15/20

(52) U.S. Cl. CPC B32B 3/18; B32B 5/02; B32B 7/12; B32B 11/08; B32B 11/10; B32B 15/14; B32B 15/20; B32B 2307/7376; B32B 2419/06

(57) ABSTRACT

A method for sealing a substrate including steps: i) providing a membrane sheet including a barrier layer and a plurality of spaced-apart strips on a lower major surface of the barrier layer, ii) providing a fresh cementitious adhesive composition, iii) applying the fresh cementitious adhesive composition to a surface of the substrate to form a wet adhesive layer, iv) covering at least a portion of the wet adhesive layer with the membrane sheet such that at least a portion of the outer surfaces of the strips are directly contacted with the wet adhesive layer, and v) letting the wet adhesive layer to harden to effect adhesive bonding between the membrane sheet and the substrate.

### TECHNICAL FIELD

The invention relates to sealing substrates using watertight or water vapor resistant membranes. Particularly, the invention relates to sealing of roof substrates against penetration of moisture and/or water.

### BACKGROUND ART

In the field of construction, polymeric and bituminous membranes are used to protect underground and above ground constructions, such as base slabs, walls, floors, basements, tunnels, wet rooms, building facades, flat and low-sloped roofs, landfills, water-retaining structures, ponds, and dikes against penetration of water, moisture, and harmful gases. Waterproofing membranes are applied, for example, to prevent ingress of water through cracks that develop in the concrete structure due to building settlement, load deflection or concrete shrinkage.

Roofing membranes are used for sealing of flat and low-sloped roof structures against penetration of water and to move water off the roof. The membranes can be adhered to a surface of the substrate, for example, by using adhesives or mechanical fastening means, such as screws with plates. Bitumen membranes are provided as “torch-on” (torch-applied) and self-adhering versions. Torch-on bitumen membranes are rolled out onto the substrate, and a construction worker uses a hand-held propane torch to heat the material and adhere it to the surface of the substrate.

Vapor control membranes having varying vapor permeability are commonly used for controlling the movement of water through a building structure by vapor diffusion. These types of membranes, which are also known as vapor control layers (VLC), are typically provided as coatings or as single- or multilayer composites comprising at least one layer composed of thermoplastic or bituminous material. Vapor control systems having a higher thickness are also known as “structural” vapor diffusion retarders.

Vapor control membranes having a low vapor permeability are typically installed in a roof system below the insulation board to prevent moisture from diffusing from the interior of the building to the space between the insulation board and the roof deck. Vapor control membranes having a Sd value of >100 m measured by equivalent air layer thickness (Sd value) according to ISO 12572 standard are used when the rooms below are considered to have medium or low amount of humidity whereas membranes having a Sd value of >1000 m are applied when the humidity below is high or very high.

Commonly used materials for the vapor control and roofing membranes include bituminous compounds and thermoplastic polymers. Polymeric materials having a low surface energy, such as polyolefin-based materials, are notoriously difficult to bond with adhesives that are commonly used in the field of construction industry. Therefore, vapor control membranes are typically bonded to the roof deck using contact adhesives or pressure sensitive adhesives. Both water- and solvent-based contact adhesives have known disadvantages related to long curing (drying) times, limitations in application temperature, and solvent emissions. Sealing a substrate having a rough surface, such as a concrete roof deck, also requires use of relatively thick adhesive layers to ensure sufficient bond strength to the substrate, which significantly increases the total costs of the roof system and also limits the number of suitable adhesives.

Most importantly, the adhesives as discussed above cannot be used for bonding of membranes to wet or damp surfaces, such as to a surface of a green concrete substrate, i.e., a concrete substrate that has not yet been fully hardened. It has been found out that even small amount of residual moisture on the surface of a concrete substrate is critical for an effective bonding of a membrane to the substrate using commonly available adhesives.

Bonding of vapor control membranes to green concrete is associated with an additional challenge, since the low permeability of the membrane prevents the residual water present in the green concrete from escaping by diffusion. Consequently, the residual water present on the surface of the concrete substrate tends to remain entrapped between the membrane and the substrate and form bubbles, which may cause the membrane to become damaged by “blistering” or even debonding of the membrane.

Providing a method for sealing green concrete substrates, particularly for concrete roof decks, would be highly desirable, since it would enable significant shortening of installation times of most types of roof systems. According to an industry standard, a vapor control or roofing membrane can only be applied to concrete substrates that have been allowed to harden for at least 28 days after casting of the concrete mass. The aforementioned curing time is recommended by concrete manufacturers in order to achieve the required compressive strength but there is no correlation between curing and dryness of the concrete mass.

There is thus a need for a novel method, which enables bonding of vapor control membranes and roofing membranes to concrete substrates, particularly to green concrete roof decks.

### SUMMARY OF THE INVENTION

The objective of the present invention is to provide a method for sealing a substrate having a damp or wet surface, such as a green concrete surface, particularly for a concrete roof deck, against penetration of moisture and/or water.

Another objective of the invention is to provide a method for preparing a roof system with reduced installation time.

Surprisingly, it was found that these objects can be achieved with the method according to the independent claim 1.

Particularly, it was surprisingly found that a membrane having spaced-apart strips on its lower surface can be bonded to a wet or damp surface of substrate, such as surface of a green concrete substrate, using a fresh cementitious adhesive. Furthermore, it was surprisingly found out that the presence of the strips on the lower surface of the membrane effectively reduces the formation of bubbles from the residual moisture in the space between the membrane and the substrate, which prevents damaging of the membrane by blistering.

Specifically, according to the invention, a method for sealing a substrate comprising steps:
i) Providing a membrane sheet comprising a barrier layer and a plurality of spaced-apart strips on a lower major surface of the barrier layer,
ii) Providing a fresh cementitious adhesive composition,
iii) Applying the fresh cementitious adhesive composition to a surface of the substrate to form a wet adhesive layer,
iv) Covering at least a portion of the wet adhesive layer with the membrane sheet such that at least a portion of the outer surfaces of the strips are directly contacted with the wet adhesive layer, and
v) Letting the wet adhesive layer to harden to effect adhesive bonding between the membrane sheet and the substrate.

In the inventive method, a fresh cementitious adhesive composition is applied as a layer on a surface of the substrate, which is covered with a membrane sheet such that the wet adhesive layer forms an interlayer between the membrane sheet and substrate. The fresh cementitious adhesive composition is then let to harden to effect adhesive bonding between the membrane sheet and the substrate.

It is essential to the present invention that the strips are spaced-apart, i.e., that they cover only a portion of the area of the lower surface of the barrier layer. Once the membrane sheet is contacted with a layer of fresh cementitious adhesive, free inter-spaces are formed between the strips which significantly improves the diffusion of water vapor and prevents the formation of bubbles from the residual moisture of the substate and/or the fresh cementitious adhesive. Without the free inter-spaces, the residual moisture could be trapped between the membrane sheet and the substrate resulting in damaging of the membrane through blistering.

In the context of roofing, the inventive method for sealing a substrate enables significant time savings in installation of typical roof systems. Especially, the method enables application of a membrane to a surface of a green concrete substrate, i.e., a poured concrete mass that has not yet been fully hardened. According to an industry standard, a concrete roof deck is let to harden at least 28 days after the casting before the installation of a new roof is started. On the other hand, the roofing is a critical step in building project since installation of the interior and finishing components cannot be complete until the roof has been installed.

By using the inventive sealing method, the installation of a new roof can be started much earlier after pouring of the concrete deck when the concrete still contains significant amount of residual moisture. Consequently, the use of the inventive method not only enables faster installation of a roof system, but it also enables significant savings in both time and costs during a construction project.

Other subjects of the present invention are presented in other independent claims. Preferred aspects of the invention are presented in the dependent claims.

### BRIEF DESCRIPTION OF THE DRAWINGS

FIG. 1 shows a cross-section of a membrane sheet (1) comprising a barrier layer (2) and a plurality of spaced-apart strips (3) on the lower major surface of the barrier layer (2).

FIG. 2. shows a cross-section of a membrane sheet (1) comprising a barrier layer (2) comprising upper and lower layers (41, 42), reinforcing layer (5) between the upper and lower layers (41, 42), and a plurality of spaced-apart strips (3) on the lower major surface of the lower layer (42).

FIG. 3 shows a perspective view of a membrane sheet (1) having a length (L) and a width (W) and comprising a barrier layer (2) and a plurality of spaced-apart strips (3) on the lower major surface of the barrier layer (2)

FIG. 4 shows a schematic presentation of a u-notched trowel for applying a fresh cementitious composition having a plurality of ridges, which have a width (w), height (h), and a spacing (s).

FIG. 5 shows a cross-section of a roof system comprising a membrane sheet (1) and a roof substrate (6), wherein the membrane (1) is adhered to a surface of the roof substrate (6) via a cementitious adhesive layer (7).

FIG. 6 shows a cross-section of a roof system of FIG. 5, wherein the roof system further comprises an insulation board (8) and a roofing membrane (9).

### DETAILED DESCRIPTION OF THE INVENTION

The subject of the present invention is a method for sealing a substrate comprising steps:
i) Providing a membrane sheet comprising a barrier layer and a plurality of spaced-apart strips on a lower major surface of the barrier layer,
ii) Providing a fresh cementitious adhesive composition,
iii) Applying the fresh cementitious adhesive composition to a surface of the substrate to form a wet adhesive layer,
iv) Covering at least a portion of the wet adhesive layer with the membrane sheet such that at least a portion of the outer surfaces of the strips are directly contacted with the wet adhesive layer, and
v) Letting the wet adhesive layer to harden to effect adhesive bonding between the membrane sheet and the substrate.

The term “polymer” refers to a collective of chemically uniform macromolecules produced by a polyreaction (polymerization, polyaddition, polycondensation) where the macromolecules differ with respect to their degree of polymerization, molecular weight, and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “copolymer” refers in the present disclosure to a polymer derived from more than one species of monomer (“structural unit”). The polymerization of monomers into copolymers is called copolymerization. Copolymers obtained by copolymerization of two monomer species are known as bipolymers and those obtained from three and four monomer species are called terpolymers and quaterpolymers, respectively.

Term “polyolefin” refers in the present disclosure to homopolymers and copolymers obtained by polymerization of olefins optionally with other types of comonomers.

The term “rubber” refers in the present disclosure to a polymer or a polymer blend, which is capable of recovering from large deformations, and which can be, or already is, modified to a state in which it is essentially insoluble (but can swell) in a boiling solvent, in particular xylene. Typical rubbers are capable of being elongated or deformed to at least 200% of their original dimension under an externally applied force, and will substantially resume the original dimensions, sustaining only small permanent set (typically no more than about 20%), after the external force is released. As used herein, the term “rubber” may be used interchangeably with the term “elastomer.”

The term “molecular weight” designates the molar mass (g/mol) of a molecule or a part of a molecule, also referred to as “moiety”. The term “average molecular weight” refers to number or weight average molecular weight (Mn, Mw) of an oligomeric or polymeric mixture of molecules or moieties. The molecular weight can be determined by conventional methods, preferably by gel permeation-chromatography (GPC) using polystyrene as standard, styrene-divinylbenzene gel with porosity of 100 Angstrom, 1000 Angstrom and 10000 Angstrom as the column, and depending on the molecule, tetrahydrofurane as a solvent at 35° C. or 1,2,4-trichlorobenzene as a solvent at 160° C.

The term “melting temperature” designates a temperature at which a material undergoes transition from the solid to the liquid state. The melting temperature (Tₘ) is preferably determined by differential scanning calorimetry (DSC) according to ISO 11357-3:2018 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T₉) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one ethylene vinyl acetate copolymer” refers to the sum of the individual amounts of all ethylene vinyl acetate copolymers contained in the composition. Furthermore, in case the composition comprises 20 wt.-% of at least one ethylene vinyl acetate copolymer, the sum of the amounts of all ethylene vinyl acetate copolymer contained in the composition equals 20 wt.-%.

The term “normal room temperature” refers to the temperature of 23° C.

The first step of the sealing method comprises providing a membrane sheet.

Membranes used in the field of construction are typically provided in a form of pre-fabricated articles, which are delivered to the construction site in form of rolls. Providing a membrane sheet may comprise unwinding the membrane roll and cutting it to membrane sheets having a suitable length.

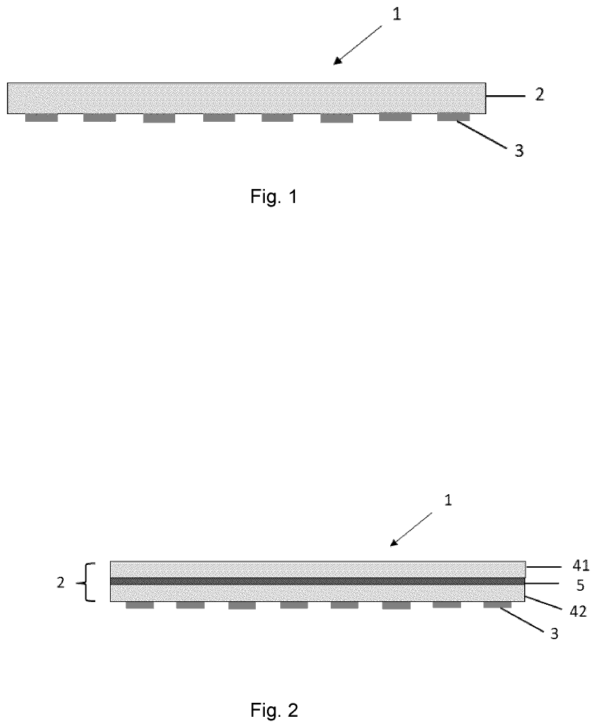

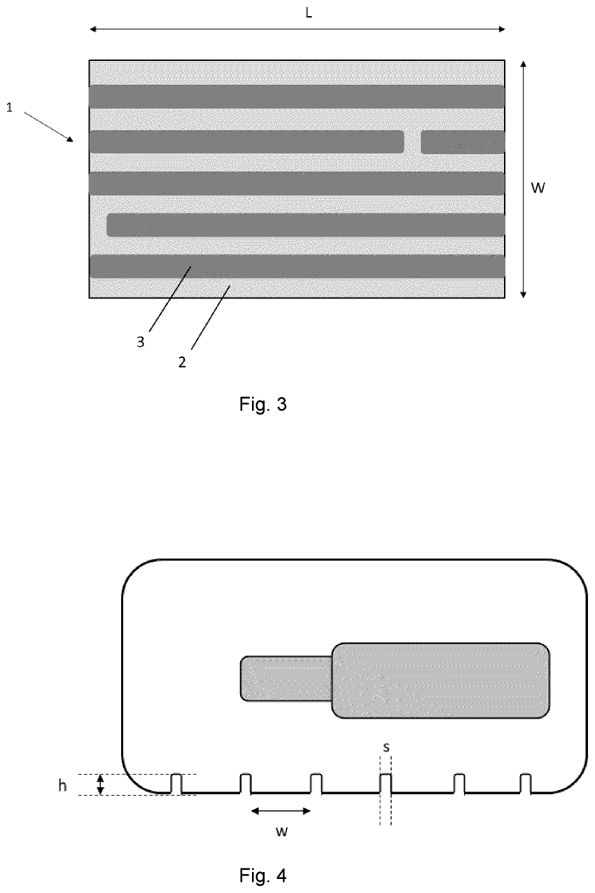

The membrane sheet comprises a barrier layer (2) and a plurality of spaced-apart strips (3) on a lower major surface of the barrier layer, as shown in FIGS. 1 and 3. The term “spaced-apart” is understood to mean that adjacent strips are isolated from each other by an area that is not covered with strips. The term “barrier layer” refers to a layer that restricts or essentially prevents some substance, such as moisture and/or water, from passing through the layer. The barrier layer may be composed of single layer of material or of multiple layers of same or different materials.

Furthermore, the term “layer” refers in the present disclosure to a sheet-like element having upper and lower major surfaces, i.e., top and bottom surfaces, defining a thickness of the layer therebetween. Preferably, the term “layer” refers to a sheet-like element having a length and width of at least 15 times, more preferably at least 25 times, even more preferably at least 50 times, greater than the thickness of the sheet-like element.

As discussed above, an essential feature of the inventive method is that the spaced-apart strips of the membrane cover only a portion of the lower major surface of the barrier layer. Preferably, said strips cover not more than 85%, preferably not more than 75%, more preferably not more than 65%, of the lower major surface of the barrier layer.

According to one or more preferred embodiments, said strips cover 15-85%, preferably 25-75%, more preferably 35-65%, of the lower major surface of the vapor control layer.

Preferably, the strips extend to the longitudinal direction of the membrane sheet. The longitudinally extending strips may be continuous, i.e., they may extend without interruption between the transverse edges of the membrane sheet. However, it may be preferred that at least a portion of the longitudinally extending strips are not continuous and that each strip is composed of at least two portions separated by a free space that is not covered with any strips.

According to one or more preferred embodiments, the strips have a thickness of 0.1-3 mm, preferably 0.25-2.5 mm, more preferably 0.5-2 mm and/or a width of 2.5-40 mm, preferably 5-35 mm, more preferably 5-30 mm. The term “width” of a strip refers here to a dimension of a strip measured in the horizontal plane of the strip and in a direction that is transverse to the longitudinal direction of the strip.

It is possible that some of the strips have a have a smaller or greater width than the other strips and/or that the width of the strips varies along the length of the strips. However, it is generally preferred that the width of the strips remains substantially constant along the longitudinal direction of the membrane sheet. According to one or more embodiments, the strips have substantially the same width.

In the subsequent steps ii) to iv) of the method, a fresh cementitious adhesive composition is provided and applied to a surface of a substrate to form a wet adhesive layer, which is covered with the membrane sheet such that at least a portion of the outer surface of the strips are directly contacted with the wet adhesive layer. The term “outer surface” of the strips refers here to the outermost surface of the strips facing away from the barrier layer.

According to one or more preferred embodiments, the step iv) of the method further comprises pressing the membrane sheet against the surface of the substrate using a slight pressure. The expression “slight pressure” is understood to mean that the pressure applied to the membrane sheet is sufficient to ensure that a majority of the outer surfaces of the strips, such as at least 75%, preferably at least 95%, become directly connected with the wet adhesive layer.

Depending on the detailed composition of the fresh cementitious adhesive composition and/or of the substrate to be sealed, it may be preferred, although not always necessary, to increase the moisture content of the substrate before the fresh cementitious adhesive composition is applied to its surface. Therefore, in some implementations, step iii) of the method is preceded by a step of applying water to the surface of the substrate to increase the surface moisture content of the substrate. The water can be applied by using any conventional techniques, for example, by spraying and/or by using a brush.

The fresh cementitious adhesive composition is preferably applied to the surface of the substrate by using a trowel, preferably u-notched or square-notched trowel. Such trowels are well known to a person skilled in the art in the field of construction. Suitable trowels comprise a plurality of ridges/notches having a width (w) and height (h), wherein the adjacent ridges/notches are separated from each other by a spacing (s). An example of u-notched trowel is shown in FIG. 4.

Furthermore, it has been found out that certain designs of the trowel are preferred to ensure proper application of the fresh cementitious adhesive composition and, especially, to ensure that the partial bonding of the membrane sheet though the strips can be realized.

According to one or more embodiments, the ridges of the trowel have:
a width (w) of 5-30 mm, preferably 7.5-25 mm, more preferably 7.5-20 mm and/or
a height (h) of 0.25-2.5 mm, preferably 0.5-2.5 mm, more preferably 0.5-2 mm and/or
a spacing (s) of 0.25-2.5 mm, preferably 0.5-2.5 mm, more preferably 0.5-2 mm.

According to one or more embodiments, the strips are composed of a self-adhering composition, preferably of a self-adhering bituminous composition.

The composition of the self-adhering bituminous composition is not particularly restricted as long as it provides the membrane sheet with sufficient bonding properties.

According to one or more embodiments, the self-adhering bituminous composition comprises:
a) At least 35 wt.-%, preferably at least 50 wt.-%, of bitumen B and
b) 5-35 wt.-%, preferably 10-30 wt.-%, of at least one modifying polymer MP, all proportions being based on the total weight of the self-adhering bituminous composition.

The term “bitumen” designates in the present disclosure blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically has low penetration values and high softening-points.

According to one or more embodiments, the bitumen B comprises at least 75 wt.-%, preferably at least 85 wt.-%, more preferably at least 90 wt.-% of at least one penetration grade bitumen, preferably having a penetration value in the range of 30-300 dmm, more preferably 70-220 dmm, even more preferably 100-160 dmm and/or a softening point determined by Ring and Ball measurement conducted according to DIN EN 1238 standard in the range of 30-100° C., more preferably 30-70° C., even more preferably 30-50° C.

Suitable compounds for use as the modifying polymer MP include, for example, polyolefins, such as atactic polypropylene (APP), amorphous polyolefins (APO), styrene block copolymers, and rubbers.

The term “amorphous polyolefin (APO)” refers in the present disclosure to polyolefins to having a low crystallinity degree determined by a differential scanning calorimetry (DSC) measurements, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. In particular, the term “amorphous polyolefin” designates poly-α-olefins lacking a crystalline melting point (Tₘ) as determined by differential scanning calorimetric (DSC) or equivalent technique.

Suitable amorphous polyolefins for use as the modifying polymer MP include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Suitable styrene block copolymers for use as the modifying polymer MP include, particularly styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks. Preferred styrene block copolymers for use as the modifying polymer MP include at least styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

Suitable rubbers for use as the modifying polymer MP include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

According to one or more embodiments, the self-adhering bituminous composition further comprises:
c) 0.1-15 wt.-%, preferably 0.5-10 wt.-%, more preferably 0.5-5 wt.-%, of at least one tackifying resin TR and/or
d) 0.1-15 wt.-%, preferably 0.5-10 wt.-%, more preferably 0.5-5 wt.-%, of at least one plasticizer PL and/or
e) 0-30 wt. %, preferably 5-25 wt.-%, more preferably 5-10 wt.-%, of at least one inorganic filler F, all proportions being based on the total weight of the self-adhering bituminous composition.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C. Examples of suitable tackifying resins include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins.

Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mn), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RÜTGERS Novares GmbH); and under the trade name of Kristalex®, Plastolyn®, Piccotex®, Piccolastic® and Endex® (all from Eastman Chemicals).

According to one or more embodiments, the at least one tackifying resin TR has:
a softening point measured by a Ring and Ball method according to DIN EN 1238 standard in the range of 65-185° C., preferably 75-175° C., more preferably 80-170° C. and/or
a number average molecular weight (Mn) in the range of 150-5000 g/mol, preferably 250-3500 g/mol, more preferably 250-2500 g/mol and/or
a glass transition temperature (T₉) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C., even more preferably at or above 30° C., still more preferably at or above 35° C.

Suitable compounds to be used as plasticizers PL are liquid plasticizers, wherein the term “liquid” is defined as a material that flows at normal room temperature, has a pour point of less than 20° C. and/or a kinematic viscosity at 25° C. of 50000 cSt or less. According to one or more embodiments, the at least one plasticizer PL is selected from the group consisting of mineral oils, synthetic oils, vegetable oils, and at 25° C. liquid hydrocarbon resins.

The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In other words, the term “mineral” refers in the present disclosure to refined mineral oils, which can be also characterized as Group I-Ill base oils according to the classification of the American Petroleum Institute (API).

Suitable mineral oils to be used as the plasticizer PL include paraffinic, naphthenic, and aromatic mineral oils. Particularly suitable mineral oils include paraffinic and naphthenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

Suitable at 25° C. liquid hydrocarbon resins for use as the plasticizer PL include at 25° C. liquid polybutenes and at 25° C. liquid polyisobutylenes (PIB). The term “at 25° C. liquid polybutene” designates in the present disclosure low molecular weight olefin oligomers comprising isobutylene and/or 1-butene and/or 2-butene. The ratio of the C₄-olefin isomers can vary by manufacturer and by grade. When the C4-olefin is exclusively 1-butene, the material is referred to as “poly-n-butene” or “PNB”. The term “at 25° C. liquid polyisobutylene” designates in the present disclosure low molecular weight polyolefins and olefin oligomers of isobutylene, preferably containing at least 75%, more preferably at least 85% of repeat units derived from isobutylene. Particularly suitable at 25° C. liquid polybutenes and polyisobutylenes have a molecular weight (Mn) of not more than 10000 g/mol, preferably not more than 5000 g/mol, more preferably not more than 3500 g/mol, even more preferably not more than 3000 g/mol, still more preferably not more than 2500 g/mol.

Liquid polybutenes are commercially available, for example, under the trade name of Indopol® H- and L-series (from Ineos Oligomers), under the trade name of Infineum® C-series and Parapol® series (from Infineum), and under the trade name of PB-series (Daelim). Liquid polyisobutylenes (PIBs) are commercially available, for example, under the trade name of Glissopal® V-series (from BASF) and and under the trade name of Dynapak®-series (from Univar GmbH, Germany).

Suitable compounds to be used as the inorganic filler F include, for example, sand, granite, calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

The term “sand” refers in the present disclosure to mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” as inert mineral filler refers in the present document to calcitic fillers produced from chalk, limestone, or marble by grinding and/or precipitation.

According to one or more embodiments, the at least one inorganic filler F is selected from the group consisting of calcium carbonate, clay, expanded clay, diatomaceous earth, pumice, mica, kaolin, talc, dolomite, xonotlite, perlite, vermiculite, Wollastonite, barite, magnesium carbonate, calcium hydroxide, calcium aluminates, silica, fumed silica, and fused silica.

Preferably, the at least one inorganic filler F has a median particle size d₅₀ of not more than 150 μm, more preferably not more than 100 μm. According to one or more embodiments, the at least one solid filler F has a median particle size d₅₀ of 0.1-100 μm, preferably 0.15-50 μm, more preferably 0.15-25 μm, even more preferably 0.25-15 μm.

The term “particle size” refers in the present disclosure to the area-equivalent spherical diameter of a particle (Xₐᵣₑₐ). The term “median particle size d₅₀” refers to a particle size below which 50% of all particles by volume are smaller than the d₅₀ value. In analogy, the term d₉₀ particle size refers in the present disclosure to a particle size below which 90% of all particles by volume are smaller than the d₉₀ value and term “d₁₀ particle size” refers to a particle size below which 10% of all particles by volume are smaller than the d₁₀ value. A particle size distribution can be measured by laser diffraction according to the method as described in standard ISO 13320:2009 using a wet or dry dispersion method and for example, a Mastersizer 2000 device (trademark of Malvern Instruments Ltd, GB).

The detailed composition of the barrier layer is not particularly restricted, and it depends mainly on the application requirements. For example, if the membrane sheet is used for sealing a substrate below which the humidity is high or very high, the barrier layer preferably has a very high Sd value, such as at least 1000 m, more preferably at least 1500 m, wherein the Sd value is measured by equivalent air layer thickness according to ISO 12572:2017-5 standard. Such barrier layers are typically characterized as “vapor barriers”.

On the other hand, if the membrane sheet is used for sealing the substrate against the penetration of water, i.e., as a roofing membrane, the barrier layer should provide sufficient watertightness for the membrane to pass the test for watertightness according to EN 1928:2000 standard.

According to one or more embodiments, the barrier layer (2) comprises upper and lower layers (41, 42) composed of a bituminous composition and a reinforcing layer (5) located between the upper and lower layers. An exemplary membrane sheet according to these embodiments is shown in FIG. 2.

In case of a porous reinforcing layer, the layer is preferably impregnated with the bituminous composition.

The bituminous composition of the upper and lower layers can be the self-adhering bituminous composition as discussed above. It may, however, be preferred to use other types of bituminous compositions, particularly non-self-adhering bituminous compositions in the barrier layer.

According to one or more embodiments, the reinforcing layer comprises at least one of a non-woven, woven, laid scrim, and a metal film.

The term “non-woven” refers in the present disclosure to materials composed of fibers, which are bonded together by using chemical, mechanical, or thermal bonding means, and which are neither woven nor knitted. Non-woven can be produced, for example, by using a carding or needle punching process, in which the fibers are mechanically entangled to obtain the nonwoven. In chemical bonding, chemical binders such as adhesive materials are used to hold the fibers together in a non-woven. Typical materials for the non-woven include synthetic organic and inorganic fibers.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90±5°, towards each other thereby forming interstices, wherein the interstices occupy more than 60% of the entire surface area of the laid scrim.

Suitable synthetic organic fibers for use in the reinforcing layer include, for example, polyethylene, polypropylene, polyester, nylon, and aramid fibers, particularly polyester fibers. Suitable inorganic fibers for the reinforcing layer include, for example, glass, carbon, metal, and wollastonite fibers, particularly glass fibers.

Especially suitable metal films for use in the reinforcing layer include aluminum films. Composite films comprising one or more metal films and one or more polymeric films are also suitable.

According to one or more preferred embodiment, the reinforcing layer is selected from a non-woven, a laid scrim, and a metal, film, wherein the non-woven preferably comprises polyester or glass fibers as the main fiber component.

The thickness of the barrier layer is not subjected to any particular restrictions. Preferably, the barrier layer has a thickness of at least 0.05 mm, more preferably at least 0.1 mm, even more preferably at least 0.15 mm. According to one or more embodiments, the vapor control layer has a thickness in the range of 0.1-10 mm, preferably 0.35-7.5 mm, more preferably 0.5-5 mm, even more preferably 0.75-3.5 mm, still more preferably 1-3 mm. The thickness of the vapor control layer can be determined by using a measurement method as defined in DIN EN 1849-2-2019-09 standard.

According to one or more embodiments, the membrane sheet further comprises a particle-based layer on an upper major surface of the upper layer of the barrier layer. The term “particle-based layer” refers to a layer composed of solid particles.

Suitable solid particles for use in the particle-based layer include, for example, inorganic particles, preferably selected from sand, talcum, gravel, and/or slates.

Preferred width (W) and length (L) of the membrane sheet depend mainly on the intended application, particularly on the type of the substrate to be sealed. According to one or more embodiments, the membrane sheet has a width (W) in the range of 0.2-5 m, preferably 0.5-3.5 m, more preferably 1-3 m.

The surface of the substrate to which the fresh cementitious adhesive composition is applied in step iii) of the method can be a primed or a non-primed surface, preferably a non-primed surface. The expression “primed surface” is understood to mean that the surface layer of the substrate is a primer layer, i.e., composed of a primer composition.

Primers are commonly used to enhance adhesion of adhesives, coatings, and sealants to substrates.

According to one or more preferred embodiments, the substrate to be sealed is a roof substrate, preferably a concrete roof deck, more preferably a green concrete roof deck.

According to one or more embodiments, the concrete roof deck is a lightweight structural concrete roof deck, preferably a green lightweight structural concrete roof deck.

Lightweight structural concrete is produced by mixing large and small aggregates, Portland cement, water and, in some instances, ad-mixtures such as fly ash or various chemical additives. The primary difference between lightweight and normal-weight structural concrete is the types of aggregates used in the concrete formulation. Normal-weight structural concrete contains normal-weight aggregates such as stone or crushed gravel, which are dense and typically absorb less than about 2 wt.-% of moisture.

Lightweight structural concrete contains lightweight, porous aggregates such as expanded shale, which will absorb about 5 to 25 wt.-% of moisture. The aggregates used in lightweight structural concrete must be saturated with moisture and, therefore, they are often stored in ponds before mixing with other constituents of the concrete. Consequently, lightweight structural concrete inherently contains much more water than normal-weight structural concrete.

The term “green concrete roof deck” refers in the present disclosure to a casted concrete roof deck that has not yet been fully hardened, i.e., a concrete roof deck that has been allowed to cure for less than less than 28 days after the casting of the concrete mass.

According to one or more embodiments, the method comprises a further step of providing a further membrane sheet comprising a barrier layer and a plurality of spaced-apart strips on a lower major surface of the barrier layer, wherein the further membrane sheet is applied such that an edge portion of the further membrane sheet is overlapping an edge portion of the membrane sheet to form an overlapping joint.

The further membrane can be applied to cover at least a portion of the wet adhesive layer formed in step iii) or the method can comprise a further step of forming a further wet adhesive layer, which is then at least partially covered with the further adhesive layer.

The opposite surfaces of the overlapped edge portions of the membrane sheets can be bonded to each other, preferably by using heat-welding or adhesive bonding means.

The heat-welding step preferably comprises heating the edge portions of the membrane sheets slightly above the melting temperature of the membrane material and pressing the edge portions to each other using sufficient pressure to provide acceptable seam strength without use of adhesives.

Alternatively, the edge portions can be bonding to each other using a suitable adhesive or a bituminous mastic.

The fresh cementitious adhesive composition provided in step ii) of the method is preferably obtained by mixing a cementitious adhesive with water.

According to one or more embodiments, the cementitious adhesive comprises:
A) 0.5-35 wt.-%, preferably 0.5-30 wt. %, more preferably 1-25 wt.-%, even more preferably 1-20 wt.-%, of at least one synthetic organic polymer SP and
B) 25-95 wt.-%, preferably 35-90 wt.-%, more preferably 40-90 wt.-%, even more preferably 50-90 wt.-%, of at least one hydraulic binder H, said proportions being based on the total weight of the cementitious adhesive.

The cementitious adhesive that is mixed with water can be a one-component adhesive or a multiple-component adhesive. In the present disclosure, the term “one-component” refers to a composition in which all constituents of the composition are stored in a mixture in the same container or compartment whereas a “multiple-component” refers to a composition in which the constituents of the composition are present in multiple different components that are stored in separate containers or compartments.

According to one or more preferred embodiments, the cementitious adhesive is a one-component adhesive, preferably in form of a powder, more preferably a free-flowing powder. The term “powder” refers here to a material that is in form of solid particles whereas “free-flowing powder” refers to a powder, in which the particles do not stick together to form aggregates.

Suitable polymers for use as the at least one synthetic organic polymer SP include, for example, copolymers obtained from free radical polymerization of monomers selected from the group consisting of ethylene, propylene butylene, isoprene, butadiene, styrene, acrylonitrile, (meth)acrylic acid, (meth)acrylate, vinyl ester, and vinyl chloride and polyurethane polymers. The term “polyurethane polymer” refers in the present disclosure to polymers prepared by so called diisocyanate polyaddition process, including those polymers which are almost or completely free of urethane groups. Examples of polyurethane polymers are polyether polyurethanes, polyester polyurethanes, polyether polyureas, polyureas, polyester polyureas, polyisocyanurates, and polycarbodiimides. The term (meth)acrylate refers to acrylate and methacrylate.

According to one or more embodiments, the at least one organic polymer SP is a copolymer, such as a random copolymer or a block copolymer, preferably obtained by polymerization of two or more different types of monomers, preferably selected from the group consisting of copolymers of vinyl acetate and ethylene, copolymers of vinyl acetate, ethylene, and (meth)acrylate, copolymers of vinyl acetate, ethylene, and vinyl ester, copolymers of vinyl chloride, ethylene, and vinyl laureate, copolymers of vinyl acetate and vinyl versatate, copolymers of (meth)acrylate and styrene, copolymers of (meth)acrylate, styrene, and butadiene, copolymers of (meth)acrylate and acrylonitrile, copolymers of styrene and butadiene, and copolymers of (meth)acrylic acid and styrene.

According to one or more preferred embodiments, the at least one synthetic organic polymer SP is in form of a re-dispersible polymer powder. The term “re-dispersible polymer powder” refers to a polymer containing powder, which when mixed with water forms a stable dispersion. A re-dispersible polymer powder is typically not composed of the polymer but comprises a mixture of the polymer with colloidal stabilizers, antiblocking agents (emulsifiers), and carrier materials. Re-dispersible polymer powders can be produced, for example, by spray-drying of water-based polymer dispersions, for example, by using the methods as disclosed in patent application EP 1042391 A1.

Suitable re-dispersible polymer powders are commercially available, for example from Wacker Chemie under the trade name of Vinnapas®, such as Vinnapas® 8000 series, from Synthomer under the trade names of Axilat®, such as Axilat® HP 8000 series, Axilat® UP series, Axilat® PSB 150, and Axilat® PAV series, and from Celanese und the trade name of Elotex®, such as Elotex® FX2320.

The cementitious adhesive further comprises at least one hydraulic binder H.

The term “hydraulic binder” refers the present document an inorganic material or blend, which forms a paste when mixed with water, and which sets and hardens by a series of hydration reactions resulting in formation of solid mineral hydrates or hydrate phases, which are not soluble in water or have a very low water-solubility. Hydraulic binders, such as Portland cement, can harden and retain their strength even when exposed to water, for example underwater or under high humidity conditions. In contrast, the term “non-hydraulic binder” refers to substances, which harden by reaction with carbon dioxide and which, therefore, do not harden in wet conditions or under water.

Preferred hydraulic binders for use as the at least one hydraulic binder H include Portland cement, aluminate cement, and calcium sulfoaluminate cement.

The term “Portland cement” as used herein is intended to include those cements normally understood to be “Portland cements”, particularly those described in European Standard EN-197. Portland cement consists mainly of tri-calcium silicate (alite) (C₃S) and dicalcium silicate (belite) (C₂S). Preferred Portland cements include the types CEM I, CEM II, CEM Ill, CEM IV, and CEM V compositions of the European standard EN 197-1:2018-11. However, all other Portland cements that are produced according to another standard, for example, according to ASTM standard, British (BSI) standard, Indian standard, or Chinese standard are also suitable.

The term “aluminate cement” as used herein is intended to include those cementitious materials that contain as the main constituent (phase) hydraulic calcium aluminates, preferably mono calcium aluminate CA (CaO·Al2O3). Depending on the type of the aluminate cement, other calcium aluminates, such as CA₂, C₃A, and C₁₂A₇, may also be present. Preferred aluminate cements include also other constituents, such as belite (C₂S), alite (C₃S), ferrites (C₂F, C₂AF, C₄AF), and ternesite (C₅S₂S). Some aluminate cements also contain calcium carbonate.

Most preferred aluminate cements for use as the at least one hydraulic binder H include calcium aluminate cements (CAC), which fulfill the requirements of the norm EN 4647 (“Calcium Aluminate Cement”). Suitable calcium aluminate cements are commercially available, for example, from Imerys Aluminates and Royal White Cement.

The term “calcium sulfoaluminate cement (CSA)” is intended to include those cementitious materials that contain as the main constituent (phase) C4(A3-xFx)3S (4CaO·3-x Al₂O₃·x Fe2O3·CaSO4), wherein x has a value of 0,1, 2, or 3. Typically, calcium sulfoaluminate cements also include other constituents, such as aluminates (CA, C₃A, C₁₂A₇), belite (C₂S), ferrites (C₂F, C₂AF, C₄AF), ternesite (C₅S₂S), and calcium sulfate. Preferred calcium sulfoaluminate cements for use as the at least one hydraulic binder H contain 20-80 wt.-% of ye'elimite (C4A3S), 0-10 wt.-% of calcium aluminate (CA), 0-70 wt.-% of belite (C₂S), 0-35 wt.-% of ferrite, preferably tetracalcium aluminoferrite (C₄AF), and 0-20 wt.-% of ternesite (C5S2S), based on the total weight of the calcium sulfoaluminate cement. Suitable calcium aluminate cements are commercially available, for example, from Heidelberg Cement AG, Vicat SA, and Caltra B.V.

According to one or more embodiments, the at least one hydraulic binder H is selected from the group consisting of Portland cement, calcium aluminate cement (CAC), and calcium sulfoaluminate cement (CSA), preferably from the group consisting of Portland cement and calcium aluminate cement (CAC).

According to one or more embodiments, the weight ratio of the amount of water to the amount of the at least one hydraulic binder H in the fresh cementitious adhesive composition obtained from step ii) is in the range of 0.1:1 to 2:1, preferably 0.2:1 to 1:1, more preferably 0.4:1 to 0.9:1, even more preferably 0.5:1 to 0.9:1.

The water can be any available water, such as distilled water, purified water, tap water, mineral water, and well water. The use of wastewater is also possible in cases where the composition of the wastewater is known and wherein none of the contaminants contained in the wastewater can influence the functionality of the constituents of the adhesive composition. The use of salt water is possible but not particularly preferred due to the high content of chlorides and the associated risk of corrosion of metal parts.

Any static or dynamic mixing device or method can be used for the mixing of the adhesive composition with water, such as a dissolver disc, blade, or other similar apparatus, as long as a macroscopically homogeneously mixed mixture can be obtained.

The fresh cementitious adhesive composition obtained from step ii) has a pot-life at normal room temperature of 15-240 min, such as 45-180 min, during which the application of the adhesive composition must be performed. The pot-life depends mainly on the amount and type of the at least one hydraulic binder H. After a time period corresponding to the pot life, the hardening reactions of the hydraulic binder H makes a subsequent application difficult or even impossible.

Furthermore, time between the steps iii) and iv) is preferably relatively short, i.e., it is not preferred that the wet adhesive layer is dried to a significant extent before it is covered with the membrane sheet. According to one or more embodiments, the interlayer formed in step iv) between the substrate and the membrane sheet contains at least 75 wt.-%, preferably at least 85 wt.-%, more preferably at least 95 wt.-%, of the amount of water contained in the fresh cementitious adhesive composition obtained from step ii).

The preferences given above for the membrane sheet and the fresh cementitious adhesive composition apply equally to all subjects of the present invention unless otherwise stated.

Another subject of the present invention is a method for providing a roof system comprising sealing a roof substrate by conducting the steps i) to v) of the method for sealing a substrate as discussed above.

According to one or more embodiments, step iii) is preceded by a step of applying water to the surface of the roof substrate to increase the surface moisture content of the roof substrate.

The roof substrate is preferably a concrete roof deck, more preferably a green concrete roof deck, even more preferably a green lightweight structural concrete roof deck.

According to one or more embodiments, the method for providing a roof system comprises a further step of applying an insulation board to an upper major surface of the membrane sheet facing away from the roof substrate.

Suitable insulation boards to be used in the roof system include, for example, foamed insulation boards, such as expanded polystyrene (EPS), extruded expanded polystyrene (XPS), and polyisocyanurate (PIR) boards.

Preferably, the insulation board comprises at least one foam panel having a closed cell structure. Suitable foam panels having a closed cell structure include molded expanded polystyrene (EPS) foam panels, extruded expanded polystyrene (XPS) foam panels, polyurethane foam panels (PUR), and polyisocyanurate (PIR) foam panels.

The thickness of the insulation board is not particularly restricted. It may be preferable that the insulation board has a thickness determined by using the measurement method as defined in DIN EN 1849-2 standard of 5-500 mm, preferably 10-350 mm, even more preferably 25-150 mm.

According to one or more embodiments, the insulation board comprises at least one foam panel having a closed cell structure selected from the group consisting of molded expanded polystyrene (EPS) foam panel, extruded expanded polystyrene (XPS) foam panel, polyurethane foam panel (PUR), and polyisocyanurate (PIR) foam panel, preferably having a density in the range of 10-150 g/l, more preferably 15-100 g/l, even more preferably

25-75 g/l.

According to one or more embodiments, the method for providing a roof system comprises a further step of applying a roofing membrane or a cover board to an upper major surface of the insulation board facing away from the membrane.

Suitable roofing membranes for use in the roof system include single- and multi-ply membranes. Commonly used materials in roofing membranes include plastics, especially thermoplastics, bitumen, and elastomers, particularly chemically crosslinked elastomers, such as ethylene-propylene diene monomer (EPDM). Suitable thermoplastics include, for example, plasticized polyvinylchloride (p-PVC) and thermoplastic olefins (TPE-O, TPO).

Single- and multi-ply roofing membranes are known to a person skilled in the art and they may be produced by any conventional means, such as by way of extrusion or co-extrusion, calendaring, or hot-pressing.

Suitable cover boards for use in the roof system include, for example, a gypsum, fiber-reinforce gypsum, plywood, compressed wood, wood fiber, cementitious, high-density (compressed) polyisocyanurate, perlite, mineral fiber, and oriented strand panels. These are durable and provide superior impact and puncture resistance.

The thickness of the cover board is not particularly restricted. It may be preferable that the cover board has a thickness of 5-250 mm, more preferably 10-200 mm, even more preferably 15-150 mm, still more preferably 30-120 mm.

The roofing membrane and cover board can be attached to the insulation board using any conventional means known to a person skilled in the art, such as by adhesive bonding means and/or mechanical fastening.

Still another subject of the present invention is a roof system obtained by using the method for providing a roof system as discussed above.

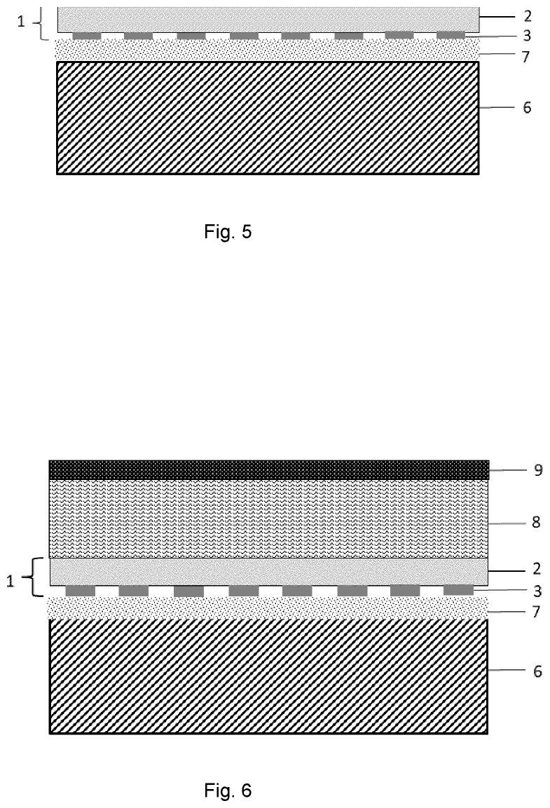

FIG. 5 shows a cross-section of a roof system comprising a membrane sheet (1) and a roof substrate (6), wherein the membrane sheet (1) comprises a barrier layer (2), wherein the membrane (1) is adhered to a surface of the roof substrate (6) via a cementitious adhesive layer (7), which forms an interlayer between the barrier layer (2) and the surface of the roof substrate (6).

FIG. 6 shows a cross-section of a roof system comprising a membrane sheet (1) and a roof substrate (6), wherein the membrane sheet (1) comprises a barrier layer (2), wherein the membrane (1) is adhered to a surface of the roof substrate (6) via a cementitious adhesive layer (7), which forms an interlayer between the barrier layer (2) and the surface of the roof substrate (6). The roof system further comprises an insulation board (8) and a roofing membrane (9), wherein the insulation board (8) is arranged between the membrane sheet (1) and the roofing membrane (9).

### Examples

The followings compounds shown in Table 1 were used in the examples:

TABLE 1

| | | |
|---|---|---|
| Membrane | SikaShield ® VMS E51 SA | Sika AG |
| Adhesive | SikaShield ® W1 | Sika AG |

SikaShield® VMS E51 SA is a commercially available vapor control membrane comprising a bituminous barrier layer and a plurality of bituminous strips on the bottom surface of the barrier layer.

SikaShield® W1 is a commercially available one-component polymer-modified cementitious adhesive.

### Adhesion Measurements

Suitability of the vapor control membrane for sealing of substrates using a cementitious compositions was tested according to the following procedure.

The one-component cementitious adhesive composition was first mixed with water using a handheld drill mixer to obtain a fresh adhesive composition. The fresh adhesive composition was then applied to a surface of a green or wet concrete substrate using a u-notched trowel to form a wet adhesive layer. The ridges of the trowel had a width (w) of 10 mm, height (h) of 1-1.5 mm, and spacing (s) of 1.5 mm.

Samples were cut from the membrane, contacted with the wet adhesive layer such that lower surfaces of the strips were directly contacted with the wet adhesive layer. The samples were then pressed against the substrate using a roll having a weigh of 40 kg and width of 50 cm.

All samples were bonded to the substrate by using the “wet lay-in” method, where the samples were directly placed on the wet adhesive layers immediately after application, i.e., without airing of the wet adhesive layer.

The substrates used in the bond adhesion measurements had been let to cure for 48 hours before testing the bonding of the sample to the surface of the substrate.

The test specimens composed of the substrate and the membrane sample bonded to its surface with the cementitious adhesive were stored for 2 days at normal room temperature. After that, the specimens were subjected a special aging treatment (at 70° C. in air, 60° C. in water) for 1, 3, or 8 months before measuring of adhesive bond strength.

The adhesive bond strength between the membrane and the substrate was determined by peel resistance and pull off force measurements.

### Pull Off Force

Pull of force was measured according to the procedure defined in EN 13596 standard with the difference that circular steel plates having a diameter of 30 mm instead of 50 mm were used in the measurements.

The values for “pull off force” shown in Table 2 have been determined as an average of 3 measurements conducted with the same membrane and adhesive under same aging conditions.

### Peel Resistance 90°

Peel resistance was measured according to the procedure defined in UEAtc Technical Guide for the Assessment of Roof Waterproofing Systems made of Reinforced APP or SBS Polymer Modified Bitumen Sheets, point 4.3.3.

In the measurements, tensile test machine as described in EN 12311-1 § 5 standard was used, and samples of the tested membrane were peeled off at a peeling angle of 90° and a constant cross beam speed of 100 mm/min.

The average peel resistance was calculated as average peel force per unit width of the strip [N/30 mm] during the peeling. The average peel resistance value shown in Table 3 was calculated as an average of measured values obtained with the same membrane.

TABLE 2

| | | Ageing at 70° C. | Ageing at 60° C. |
|---|---|---|---|
| Ageing | New | in air | in water |
| After 2 days at | 0.32 # | | |
| room temp. | | | |
| After 15 days | | | 0.274 |
| After 1 month | | 0.115 # | 0.270 |
| After 3 month | | 0.420 § | 0.160 # |
| After 8 month | | 0.425 # | 0.290 |

# Adhesive failure from the top surface of the membrane
§ Adhesive failure within the concrete adhesive

TABLE 3

| Specimen | Peel strength (N/30 mm) |
|---|---|
| Average | 255.135 |

1. A method for sealing a substrate comprising steps:
i) providing a membrane sheet comprising a barrier layer and a plurality of spaced-apart strips on a lower major surface of the barrier layer,
ii) providing a fresh cementitious adhesive composition,
iii) applying the fresh cementitious adhesive composition to a surface of the substrate to form a wet adhesive layer,
iv) covering at least a portion of the wet adhesive layer with the membrane sheet such that at least a portion of the outer surfaces of the strips are directly contacted with the wet adhesive layer, and
v) letting the wet adhesive layer to harden to effect adhesive bonding between the membrane sheet and the substrate.

2. The method according to claim 1, wherein the strips cover not more than 85% of the lower major surface of the barrier layer.

3. The method according claim 1, wherein the strips have a thickness of 0.1-3 mm.

4. The method according to claim 1, wherein step iii) is preceded by a step of applying water to the surface of the substrate to increase the surface moisture content of the substrate.

5. The method according to claim 1, wherein the fresh cementitious adhesive composition is applied to the surface of the substrate using a trowel having a plurality of ridges.

6. The method according to claim 5, wherein the ridges of the trowel have a width (w) of 5-30 mm and/or a height (h) of 0.25-2.5 mm and/or a spacing (s) of 0.25-2.5 mm.

7. The method according to claim 1, wherein the strips are composed of a self-adhering composition.

8. The method according to claim 7, wherein the self-adhering bituminous composition comprises:
a) at least 35 wt.-% of bitumen B and
b) 5-35 wt.-% of at least one modifying polymer MP, all proportions being based on the total weight of the self-adhering bituminous composition.

9. The method according to claim 1, wherein the barrier layer comprises upper and lower layers composed of a bituminous composition and a reinforcing layer located between the upper and lower layers.

10. The method according to claim 9, wherein the reinforcing layer comprises at least one of a non-woven, woven, laid scrim, and a metal film.

11. The method according to claim 1, wherein the substrate to be sealed is a roof substrate.

12. The method according to claim 1, wherein the fresh cementitious adhesive composition is obtained by mixing a cementitious adhesive with water, wherein the cementitious adhesive comprises:
A) 0.5-30 wt.-% of at least one synthetic organic polymer SP and
B) 25-95 wt.-% of at least one hydraulic binder H, the proportions being based on the total weight of the cementitious adhesive.

13. The method according to claim 12, wherein the at least one synthetic organic polymer SP is in form of a re-dispersible polymer powder.

14. The method according to claim 12, wherein the weight ratio of the amount of water to the amount of the at least one hydraulic binder H in the fresh cementitious adhesive composition obtained from step ii) is in the range of 0.1:1 to 2:1.

15. A method for providing a roof system comprising sealing a roof substrate by conducting steps i) to v) of the method as defined in claim 1.

16. The method according to claim 15 comprising a further step of applying an insulation board to an upper major surface of the membrane sheet facing away from the roof substrate.

17. The method according to claim 16 comprising a further step of applying a roofing membrane or a cover board to an upper major surface of the insulation board facing away from the membrane sheet.
